(19) United States
(12) Patent Application Publication
(10) Pub. No.: US 2009/0234741 A1
(43) Pub. Date: Sep. 17, 2009

(54) NAVIGATION SYSTEM AND PROGRAM

(75) Inventors: Akira Saitoh, Yokohama-shi (JP); Takeyuki Shimura, Sagamihara-Shi (JP); Shigeki Takeuchi, Yokohama-shi (JP); Daisuke Tomoda, Yokohama-shi (JP); Hayato Uenohara, Tokyo (JP); Satoshi Yokoyama, Yokohama-shi (JP)

Correspondence Address: KALI LAW GROUP, P.C., P.O. BOX 60187, SUNNYVALE, CA, 94088-0187, US

(73) Assignee: INTERNATIONAL BUSINESS MACHINES CORPORATION, Armonk, NY (US)

(21) Appl. No.: 12/405,122

(22) Filed: Mar. 16, 2009

(30) Foreign Application Priority Data
Mar. 14, 2008 (JP) 2008-66368

(51) Int. Cl. G01C 21/00; G06Q 30/00; G06F 17/30

(52) U.S. Cl. 705/14; 701/200; 701/207; 707/104.1; 707/E17.044

(57) ABSTRACT

Navigation systems for providing route guidance to a destination for a user are presented including: an information provider configured to provide a program for performing processing of a voice command and a grammar associated with the route guidance, the information provider including, a transmitter for sending the program, and an informing means for notifying the user of the program; a terminal device for providing the route guidance to the user, the terminal device including: a receiver for receiving the program from the information provider, a speech recognition unit for enabling the voice command and the grammar, a navigation executing unit for realizing a navigation function in response to the voice command; and a server, where the server is configured to provide data associated with the program to the information provider.

### PRIORITY CLAIM TO FOREIGN APPLICATION

A claim for priority is hereby made under the provisions of 35 U.S.C. §119 for the present application based upon Japanese Patent Application No. 2008-66368, filed on Mar. 14, 2008, which is incorporated herein by reference.

### TECHNICAL FIELD

The present invention relates to a navigation system and a program thereof for providing route guidance to a destination upon receipt of an operation command including a voice command.

### BACKGROUND

In recent years, there has been a car navigation system that is equipped with a speech recognition function and can be operated by voice commands. A user can operate a car navigation system of this type by speaking voice commands. This is very useful in that the user can use the system even during driving.

Patent Document 1 discloses a navigation apparatus capable of setting a route again even during route guidance. When a speech recognition unit, a remote control unit, or the like is operated under predetermined conditions, this navigation apparatus allows input of a command for selecting a route different from that already set.

Patent Document 2 discloses a technique of obtaining an image from inside or outside a vehicle, performing character recognition on the obtained image to support input to a vehicle-mounted information device, such as a navigation apparatus, thereby reducing burdens on an operator.

[Patent Document 1] Japanese Unexamined Patent Application Publication No. 2001-56228

[Patent Document 2] Japanese Unexamined Patent Application Publication No. 2003-67407

### BRIEF DESCRIPTION OF THE SEVERAL VIEWS OF THE DRAWINGS

FIG. 1 illustrates an overall configuration of a navigation system to which the present embodiment is applied.

FIG. 2 illustrates a functional configuration of an information provider according to the present embodiment.

FIG. 3 illustrates a functional configuration of a terminal device according to the present embodiment.

FIG. 4 illustrates a functional configuration of a service controller in the terminal device according to the present embodiment.

FIG. 5 illustrates a functional configuration of a server according to the present embodiment.

FIG. 6 illustrates a system configuration of the case where sales services of a shop are provided by applying the navigation system of the present embodiment.

### SUMMARY OF THE INVENTION

Problems to be Solved by the Invention:

A navigation system that can be operated by voice commands is convenient in that, since it can be operated by speaking an appropriate command, it can be used even during driving. However, a large number of commands are required to perform various operations only by speaking voice commands. Since the operator has to memorize these voice commands in advance, it is not easy for the operator to handle the navigation system.

Additionally, with the existing techniques, different voice commands are prepared for different types of navigation systems. Therefore, for example, when a user drives different cars for work and personal use or drives a rental car, if different types of car navigation systems are mounted on these cars, a great burden is placed on the user because the user has to use different voice commands for different car navigation systems.

An object of the present invention is to solve the problems described above and to provide a navigation system that can save users the trouble of memorizing voice commands and can provide a variety of services.

Means for Solving the Problems:

To achieve the object described above, the present invention is configured as a navigation system described below. The navigation system includes a terminal device having a navigation function and configured to receive a voice command as an operation command, and a receiver configured to receive data for use in recognizing a specific voice command. The terminal device includes a storage unit configured to store the data received by the receiver, and a speech recognition unit configured to perform speech recognition using the data stored in the storage unit.

More preferably, the receiver further receives a program describing processing to be executed in response to the specific voice command; and the terminal device further includes a program executing unit configured to execute, when the specific voice command is received, the program received by the receiver to control operation of the navigation function.

Another navigation system of the present invention includes a terminal device having a navigation function and configured to receive a voice command as an operation command, informing means for informing a user using the terminal device of a specific voice command for causing the terminal device to provide route guidance to a specific destination, a transmitter configured to transmit data for use in recognizing the specific voice command and information for the user to receive a specific service at the specific destination, and a receiver configured to receive the data and the information transmitted from the transmitter. The terminal device includes a storage unit configured to store the data and the information received by the receiver, a speech recognition unit configured to perform speech recognition using the data stored in the storage unit, and an output unit configured to output the information to the user.

More preferably, the navigation system further includes a management server configured to check whether the specific voice command has been used in the terminal device. The management server may be configured to further check whether the specific service has been executed. The terminal device further includes a transmitting unit configured to transmit, to the management server, information indicating that the specific voice command has been used and information indicating that the specific service has been executed.

Alternatively, the navigation system further includes a management server configured to check whether the specific service has been executed at the specific destination, and a service providing server configured to provide the specific service. The service providing server transmits, to the management server, information indicating that the specific service has been executed.

When the navigation system includes one of the management servers described above, the management server may serve as a charging server configured to perform charging, at a predetermined time point, to collect a fee from a provider of the specific service.

The present invention can also be realized as a program product that causes a computer to perform various functions of the navigation system described above. This program product can be provided by storing and distributing it in an optical disk, a magnetic disk, a semiconductor memory, or any other recording medium or distributing it via a network.

In other embodiments, navigation systems for providing route guidance to a destination for a user are presented including: an information provider configured to provide a program for performing processing of a voice command and a grammar associated with the route guidance, the information provider including, a transmitter for sending the program, and an informing means for notifying the user of the program; a terminal device for providing the route guidance to the user, the terminal device including: a receiver for receiving the program from the information provider, a speech recognition unit for enabling the voice command and the grammar, a navigation executing unit for realizing a navigation function in response to the voice command; and a server, where the server is configured to provide data associated with the program to the information provider. In some embodiments, the transmitter is configured to provide a data transmission mechanism that may be selected from the following without limitation: a dedicated short range communication mechanism, an active radio frequency identification mechanism, and a frequency modulation multiple wave mechanism. In some embodiments, the terminal device further includes: a profile database for storing a user profile; a media database for storing information corresponding with media set by the user as unnecessary media; and a filter unit for determining when the program is provided to the user based on data corresponding with the profile database and the media database. In some embodiments, the server further includes: an information providing server for providing data associated with program changes to the information provider; a data distributing server, where the data distribution server is configured to receive the authentication data from the information provider, where in response receiving the authentication data, the data distribution server is configured to provide a requested data to the information provider, and where, the data distribution server is configured to receive data from the terminal device; and a charging server for performing charging based on use of the voice command associated with the program.

In other embodiments, methods for providing route guidance to a navigation device including: causing a server to send a program for performing processing of a voice command and a grammar associated with the route guidance; causing an information provider to receive the program; causing the information provider to transmit a notification to a user such that the user is informed of an availability of the program; if the user utilizes the voice command, causing the navigation device to determine the route guidance associated with the program. In other embodiments, computing device program products for providing route guidance to a navigation device are presented including: a computer readable medium; programmatic instructions for causing a server to send a program for performing processing of a voice command and a grammar associated with the route guidance; programmatic instructions for causing an information provider to receive the program; programmatic instructions for causing the information provider to transmit a notification to a user such that the user is informed of an availability of the program; if the user utilizes the voice command, programmatic instructions for causing the navigation device to determine the route guidance associated with the program.

Advantages:

With the present invention configured as described above, by providing a voice command that is necessary for providing a specific service and also by providing data and a program that are necessary for processing using the voice command every time the service becomes available, it is possible to realize a navigation system that can save users the trouble of memorizing voice commands and can provide a variety of services.

### DETAILED DESCRIPTION

Hereinafter, embodiments of the present invention will be described in detail with reference to the attached drawings.

The present embodiment is applicable to a car navigation system mounted on a vehicle, a navigation system including a portable information terminal (e.g., mobile phone), and the like. The following description refers to the case where the present embodiment is applied to a car navigation system.

System Configuration:

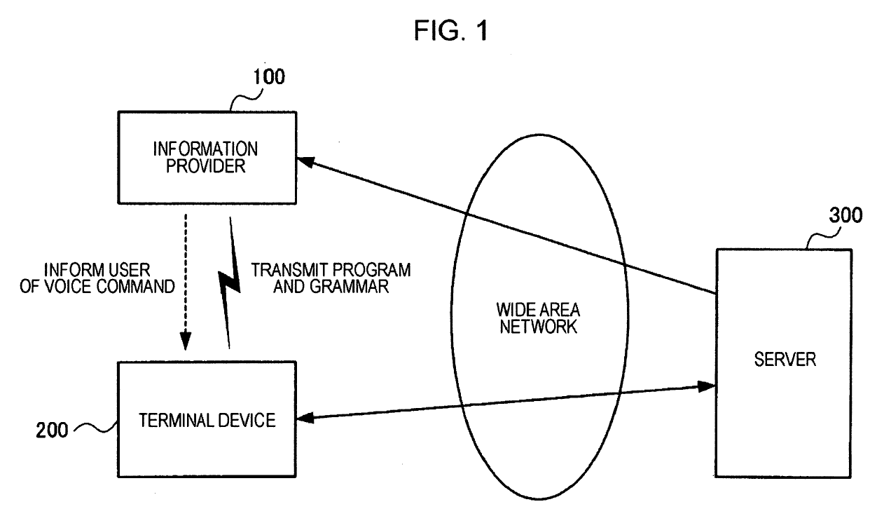

FIG. 1 illustrates an overall configuration of a navigation system to which the present embodiment is applied.

As illustrated in FIG. 1, the navigation system of the present embodiment includes an information provider 100, a terminal device 200, and a server 300. The information provider 100 and the terminal device 200 are connected to each other via various wireless communication means. The terminal device 200 and the server 300 are connected to each other via a wide area network including a wireless network. The information provider 100 and the server 300 are connected to each other via a wide area network of any type.

In the present embodiment, the information provider 100 transmits, to the terminal device 200, a program for performing processing corresponding to a voice command and a grammar for use in speech recognition. At the same time, by using a communication means such as a sign, the information provider 100 informs a user using the terminal device 200 of a voice command. When the user speaks this voice command, the voice command is recognized and the program is executed. Additionally, in the present embodiment, in processing of the program obtained from the information provider 100, the terminal device 200 performs data exchange with the server 300. This enables the user to receive various services.

Functions of Information Provider 100:

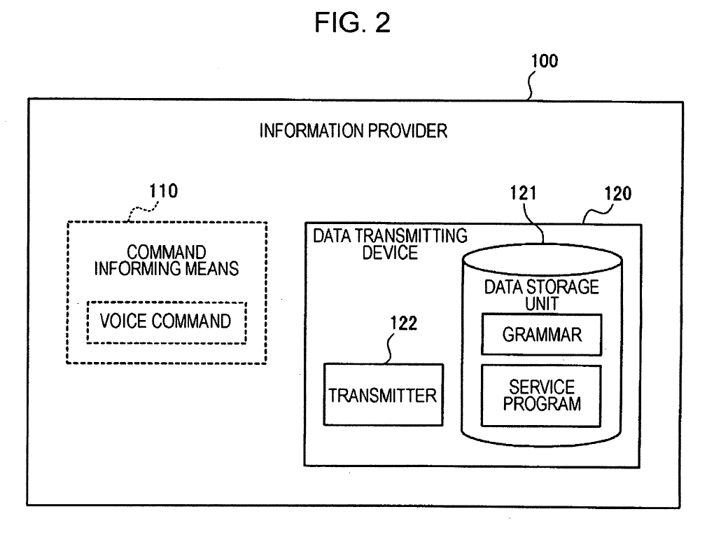

FIG. 2 illustrates a functional configuration of the information provider 100.

As illustrated in FIG. 2, the information provider 100 includes a command informing means 110 and a data transmitting device 120. The command informing means 110 informs a user using the terminal device 200 (i.e., a passenger of a vehicle) of a voice command. The data transmitting device 120 transmits information to the terminal device 200.

The command informing means 110 is a means for informing the user using the terminal device 200 of a voice command. Example of the command informing means 110 include various media, such as an advertising display (e.g., sign) and a notice board for displaying traffic information or other information. The command informing means 110 may be an audio-based medium, such as radio broadcasting.

The data transmitting device 120 is a device that transmits various types of data for processing voice commands in the terminal device 200. The data transmitting device 120 includes a data storage unit 121 that stores data and a transmitter 122 that transmits data. The data to be transmitted includes a grammar for recognizing a voice command, a program (hereinafter referred to as service program) for executing a service according to a voice command, and a media ID and/or positional information for identifying a medium (e.g., sign) serving as the command informing means 110. A preferable mechanism of data transmission is a mechanism that allows the data to be transmitted only to the terminal device 200 located within a given distance from the transmitter 122. Examples of such a data transmission mechanism include dedicated short range communication (DSRC), active radio frequency identification (RFID), and transmission through frequency modulation (FM) multiple waves.

Functions of Terminal Device 200:

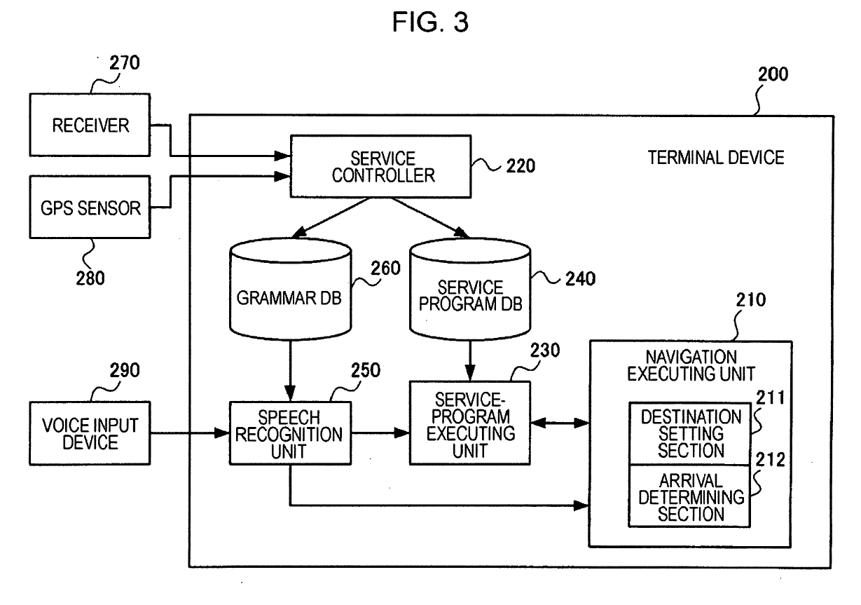

FIG. 3 illustrates a functional configuration of the terminal device 200.

As illustrated in FIG. 3, the terminal device 200 is a vehicle-mounted device mounted on a vehicle and includes a navigation executing unit 210 for realizing a navigation function, a service controller 220 that performs control for services provided in the present embodiment, a service-program executing unit 230, and a service program database (DB) 240. The terminal device 200 further includes a speech recognition unit 250 and a grammar DB 260 for performing speech recognition. While not specifically shown, the terminal device 200 further includes input means (e.g., buttons) for manually performing input of various commands and setting operations and display means (e.g., liquid crystal display) for displaying various types of information, such as maps. The terminal device 200 is provided with a network interface for access to the server 300 via a wide area network. It is preferable that the network interface be one which allows wireless access to the wide area network. Examples of the network interface include a wireless local area network (LAN) card and a mobile phone.

Also as illustrated in FIG. 3, a receiver 270, a global positioning system (GPS) sensor 280, and a voice input device 290 are connected to the terminal device 200. The receiver 270 receives data transmitted from the transmitter 122 included in the data transmitting device 120 of the information provider 100. The voice input device 290 is used for input of voice commands.

The navigation executing unit 210 is realized by a program-controlled central processing unit (CPU) and storage means, such as a memory and a magnetic disk. The navigation executing unit 210 includes a destination setting section 211 for setting a destination using map data and an arrival determining section 212 for determining whether the vehicle has arrived at a destination on the basis of map data and positional information provided by a GPS. While not specifically shown, the navigation executing unit 210 includes a storage device (e.g., magnetic disk device (HDD)) for storing map data and has a display control function for displaying, on the display means, a map generated from map data, a current position, a destination, a route, various messages, and the like.

The service controller 220 is realized by a program-controlled CPU and storage means, such as a memory and a magnetic disk. The service controller 220 obtains data from the information provider 100, performs data exchange with the server 300, and performs control for receiving services. Of the data received from the information provider 100, a service program and a grammar are stored in the service program DB 240 and the grammar DB 260, respectively, by the service controller 220. The other functions of the service controller 220 will be described in detail later.

The service program DB 240 is realized by a storage device, such as a magnetic disk device (HDD), and holds a service program received from the service controller 220. This service program is read and executed by the service-program executing unit 230. The grammar DB 260 is also realized by a storage device, such as a magnetic disk device (HDD), and holds a grammar received from the service controller 220. The speech recognition unit 250 refers to this grammar to perform speech recognition.

The service-program executing unit 230 is realized by a program-controlled CPU, a memory, and the like. The service-program executing unit 230 reads and executes a service program stored in the service program DB 240. Specifically, on the basis of the service program, the service-program executing unit 230 operates the destination setting section 211 of the navigation executing unit 210 to set a destination and causes the navigation executing unit 210 to execute route guidance. When the vehicle arrives at the destination, the service-program executing unit 230 receives an arrival notice from the arrival determining section 212 and executes specific processing, such as issuing of coupons, as described below.

The speech recognition unit 250 is realized by a program-controlled CPU, a memory, and the like. The speech recognition unit 250 refers to a grammar held in the grammar DB 260 to analyze voice input via the voice input device 290, thereby recognizing a voice command. The recognized command is transmitted to the service-program executing unit 230, which executes a service program upon receipt of this command.

The receiver 270 is a receiving device using a communication method corresponding to the transmitter 122 included in the data transmitting device 120 of the information provider 100. The receiver 270 receives data transmitted from the transmitter 122 and transmits the received data to the service controller 220.

The GPS sensor 280 is a receiving device of a so-called GPS. The GPS sensor 280 receives radio waves from the Navigation Satellite Timing and Ranging (NAVSTAR) satellites to obtain information about the current position. The GPS sensor 280 transmits the obtained information to the navigation executing unit 210 and the service controller 220.

The voice input device 290 is a microphone, which converts voice of the operator of the terminal device 200 into an electric signal and transmits the signal to the speech recognition unit 250.

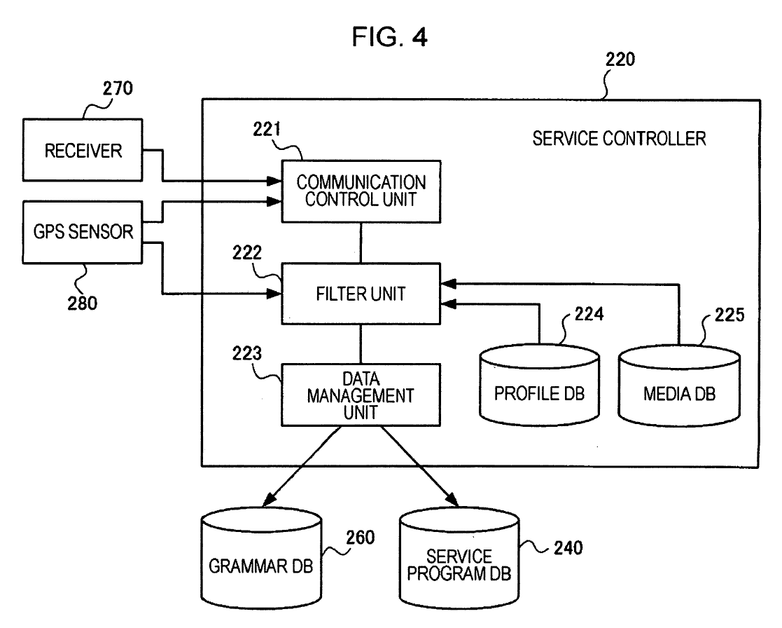

FIG. 4 illustrates a functional configuration of the service controller 220.

As illustrated in FIG. 4, the service controller 220 includes a communication control unit 221, a filter unit 222, and a data management unit 223. The service controller 220 further includes a profile DB 224 and a media DB 225. The profile DB 224 holds profile information of the user of the terminal device 200. The media DB 225 holds information for performing individual filtering on a medium by which a voice command is indicated in the information provider 100.

The communication control unit 221 receives data received from the information provider 100 via the receiver 270 and positional information received via the GPS sensor 280, and transmits the received data and positional information to the filter unit 222. Additionally, the communication control unit 221 transmits and receives data to and from the server 306 via the network interface provided in the terminal device 200.

The filter unit 222 performs filtering on data received from the communication control unit 221 and transmits, to the data management unit 223, data that can be used by the user of the terminal device 200. Here, the filter unit 222 refers to the profile DB 224 and the media DB 225 and performs filtering on the basis of positional information received via the GPS sensor 280. The filtering can be performed using existing techniques.

The profile DB 224 holds a user profile, including sex, age, hobbies, and preferences. On the basis of this profile information, the filter unit 222 selects data in which the user might be interested and transmits the selected data to the data management unit 223.

The media DB 225 holds information about media (e.g., advertisements) set by the user as unnecessary media. When voice content corresponding to data received from the communication control unit 221 is that provided by a medium identified by information held in the media DB 225, the filter unit 222 does not transmit the data to the data management unit 223.

On the basis of positional information obtained by the GPS sensor 280 and according to the current position of the vehicle (or terminal device 200), the filter unit 222 transmits data received from the communication control unit 221 to the data management unit 223. For example, only when the current position is within a given distance from a position at which the vehicle (or terminal device 200) is located when the data is received by the receiver 270, the filter unit 222 transmits the data to the data management unit 223. The filter unit 222 may use an internal clock or the like in the terminal device 200 to measure time elapsed after the data is received by the receiver 270. Then, for example, only when the time elapsed is within a given period of time, the filter unit 222 transmits the data to the data management unit 223.

The data management unit 223 performs installation, updating, and deletion of data and programs in the service program DB 240 and grammar DB 260. Specifically, every time a new program or data is received via the filter unit 222, the data management unit 223 installs the received program or data in the service program DB 240, updates a program held in the service program DB 240 with the received program, and similarly stores the received data in the grammar DB 260. If policies, such as deletion conditions, are defined for such data or programs, the data management unit 223 deletes the data or programs according to the policies.

In the configuration described above, on the basis of positional or temporal information, the filter unit 222 controls whether to transmit data received from the data transmitting device 120 to the data management unit 223. However, the service controller 220 may store data in the service program DB 240 and the grammar DB 260 without performing control on the basis of positional or temporal information. In this case, it is possible that the service-program executing unit 230 controls whether to execute a service program on the basis of positional or temporal information. It is also possible to describe, in a service program itself, such that execution control based on positional or temporal information is performed for specific processing.

A program that realizes, in cooperation with a CPU (hardware), the above-described functions of the navigation executing unit 210, service controller 220, service-program executing unit 230, and speech recognition unit 250 in tile terminal device 200 is provided, for example, by storing and distributing it in a recording medium, such as an optical disk, a magnetic disk, or a semiconductor memory or distributing it via a network.

Functions of Server 300:

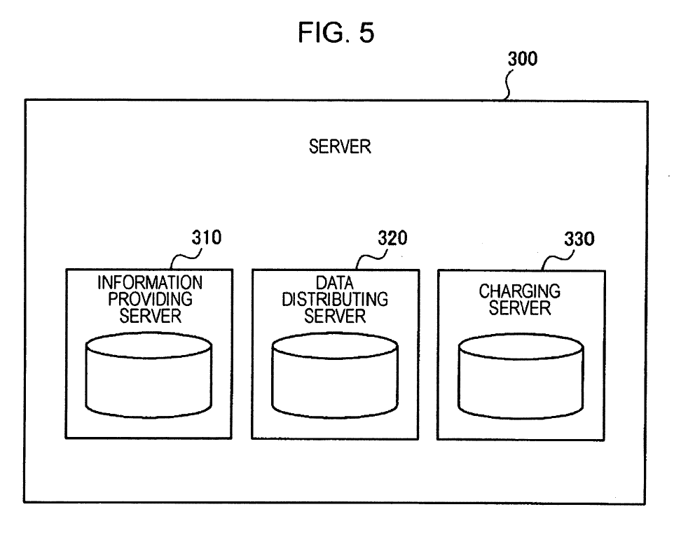

FIG. 5 illustrates a functional configuration of the server 300.

The server 300 illustrated in FIG. 5 includes a plurality of sub-servers corresponding to respective functions to be realized. For example, the server 300 includes an information providing server 310, a data distributing server 320, and a charging server 330.

The information providing server 310 provides, via a wide area network to the data transmitting device 120 of the information provider 100, various types of data transmitted from the information provider 100 to the terminal device 200. If a voice command or a service provided by a predetermined information provider 100 is changed, the information providing server 310 transmits new data to the data transmitting device 120 of the information provider 100 to cause the data transmitting device 120 to perform updating.

The data distributing server 320 holds data equivalent to data transmitted from the information provider 100 to the terminal device 200. In response to a request from the terminal, device 200, the data distributing server 320 transmits the requested data to the terminal device 200. In this case, the data transmitting device 120 of the information provider 100 does not transmit substantial data, such as a grammar or a service program, but transmits, for example, authentication data serving as a trigger. The service controller 220 of the terminal device 200 obtains data serving as a trigger, transmits the obtained data to the data distributing server 320, and obtains substantial data from the data distributing server 320.

The charging server 330 is a management server that manages use of voice commands and data provided by the information provider 100 and performs charging according to the use. For example, the charging server 330 checks whether a specific voice command provided by the information provider 100 has been used. Then, when the voice command is actually input to the terminal device 200, the charging server 330 performs charging according to the use of the voice command. Alternatively, when a specific destination is set by the service-program executing unit 230 and if the vehicle arrives at the destination or a specific service is executed at the specific destination, the service-program executing unit 230 can perform charging in response to the occurrence of such an event.

Operations:

Next, specific operations of the navigation system of the present embodiment will be described.

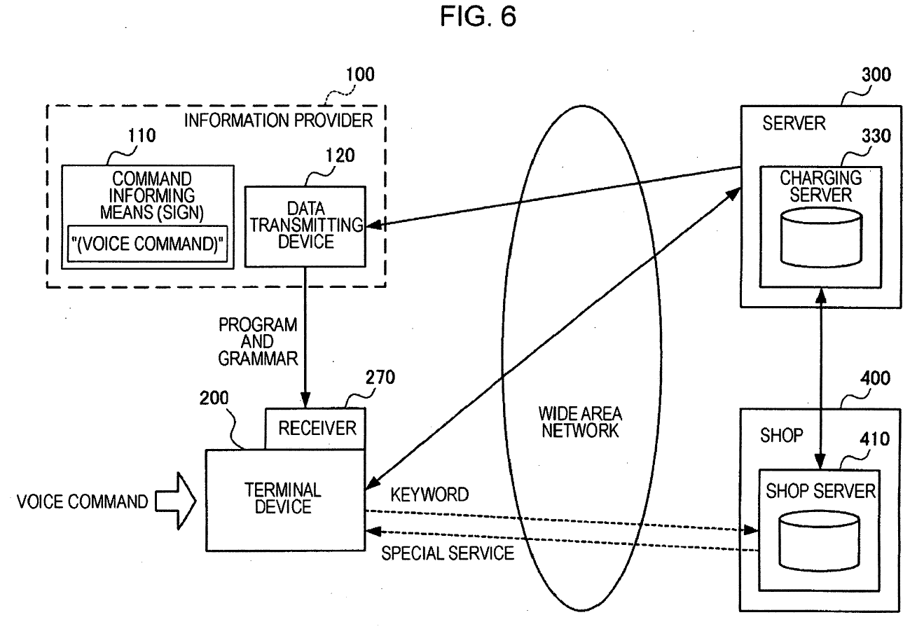

FIG. 6 illustrates a system configuration of the case where sales services of a shop are provided by applying the navigation system of the present embodiment.

Referring to FIG. 6, a shop 400 that executes sales services and a shop server 410 of the shop 400 are added to the information provider 100, terminal device 200, and server 300 shown in FIG. 1. The shop server 410 is connected to the charging server 330 in the server 300. Of the sub-servers of the server 300, only the charging server 330 is shown in FIG. 6.

The command informing means 110 of the information provider 100 is a sign that displays advertisements for the shop 400 and items sold at the shop 400. Specific phrases, such as sales messages, described on the sign are set as voice commands.

In the example of FIG. 6, there is introduced a mechanism for recognizing that a voice command provided by the command informing means 110 has been used and the user has been guided to the shop 400. Specifically, for example, only when the voice command has been used, the user of the terminal device 200 is informed of specific information, such as a keyword. Then, when the user tells a clerk the specific information at the shop 400, it can be confirmed that the voice command has been used. Alternatively, by performing direct data exchange between the terminal device 200 and the shop server 410 via the network, the terminal device 200 may inform the shop server 410 that the voice command has been used.

To encourage the user of the terminal device 200 to use a voice command provided by the command informing means 110, a special service (incentive) may be provided to the user when the voice command is used. For example, if a coupon is issued as an incentive, the user may use the voice command to use the coupon. Then, if the coupon is used, it is possible to determine that the voice command has been used. The coupon may be issued either when the voice command is used or when the vehicle arrives at the destination set on the basis of the voice command.

The charging server 330 performs data exchange with one or both of the terminal device 200 and the shop server 410 to manage execution of services at the shop 400. Then, as a result of use of a voice command provided by the information provider 100, when it can be confirmed that a service at the shop 400 has been executed, the charging server 330 performs charging to collect the advertisement fee from the shop 400.

Hereinafter, there will be described a specific scenario where the system of FIG. 6 is used.

The shop 400 is a fast-food shop (called XXX). The sign serving as the command informing means 110 of the information provider 100 displays a message “I want to go to XXX” as a voice command.

When the vehicle with the terminal device 200 passes near the data transmitting device 120 of the information provider 100, data including a service program and a grammar is transmitted from the data transmitting device 120 and received by the terminal device 200 via the receiver 270. In the terminal device 200, the service program and the grammar included in the received data are stored in the service program DB 240 and the grammar DB 260, respectively.

Next, a passenger (hereinafter referred to as user) of the vehicle finds the sign serving as the command informing means 110, recognizes the voice command on the sign, and says “I want to go to XXX” to input this voice command to the terminal device 200. Then, the speech recognition unit 250 of the terminal device 200 refers to the grammar DB 260 to perform speech recognition, thereby recognizing the voice command. On the basis of the result of this speech recognition, the service-program executing unit 230 reads and executes the service program stored in the service program DB 240. Specifically, the navigation executing unit 210 is controlled, the shop 400 is set as a destination, and route guidance is performed. Additionally, a coupon for receiving a special service from the shop 400 is issued. This coupon is provided to the user, for example, by displaying a number or an ID unique to the coupon on the display means or by outputting such a number or ID as voice.

Next, the vehicle with the terminal device 200 arrives at the shop 400 and the user purchases an item at the shop 400. The shop 400 cannot determine whether the user has used the voice command only on the basis of the fact that the user has purchased the item. However, if the user uses the coupon (i.e., the user tells a clerk the number or ID unique to the output coupon), the shop 400 can determine that the voice command has been used.

After the use of the coupon is registered in the shop server 410 at the shop 400, the registered information is transmitted from the shop server 410 to the charging server 330 in the server 300. Upon receipt of this information, the charging server 330 performs charging to collect the advertisement fee from the shop 400.

Instead of being transmitted from the shop server 410 to the charging server 330, the information indicating that the coupon has been used at the shop 400 may be informed by the terminal device 200 to the charging server 330 via the network interface. Alternatively, depending on the type of service provided, data exchange may be performed between the terminal device 200 and the shop server 410 such that the terminal device 200 or the shop server 410 recognizes the fact that the service of the shop 400 has been executed as a result of use of the voice command and informs the charging server 330 of the fact.

Instead of obtaining information about execution of the service from one of the terminal device 200 and the shop server 410, the charging server 330 may obtain the information from both the terminal device 200 and the shop server 410 and compare the information from the terminal device 200 with that from the shop server 410. In this example, charging is performed when a service is executed at the shop 400. However, use of a voice command may also be charged. In this case, upon input of a voice command, the terminal device 200 informs the charging server 330 that the voice command has been used. In response to this information, the charging server 330 executes charging to collect the advertisement fee from the shop 400. Since thus charging is performed in two steps (i.e., first for use of a voice command and then for execution of a service), it is possible to perform charging according to the degree of use of information provided by the information provider 100.

### Other Applications of the Present Embodiment

The navigation system of the present embodiment is applicable not only to a so-called car navigation system that outputs routes to a vehicle-mounted device (such as that described above) to provide route guidance. Today, portable navigation devices are available, and navigation services that provide route guidance by using easily portable information terminals (e.g., mobile phones) are widespread. Therefore, it is possible to apply the present embodiment by using any of such information terminals as the terminal device 200.

For example, when a mobile phone is used as the terminal device 200, the navigation executing unit 210, the service controller 220, the service-program executing unit 230, and the speech recognition unit 250 are realized by a program-controlled CPU of the mobile phone. The service program DB 240 and the grammar DB 260 are realized by a memory in the mobile phone. Functions of the receiver 270 connected to the terminal device 200 may either be realized by using a communication function of the mobile phone or by incorporating a wireless LAN function into the mobile phone. The existing GPS function of the mobile phone can be used to realize functions of the GPS sensor 280. A microphone of the mobile phone can be used as the voice input device 290.

Although the present embodiment has been described above, the technical scope of the present invention is not limited to that described in the foregoing embodiment. For example, depending on-the type of service provided as a result of use of a voice command, it is possible, when a vehicle with the terminal device 200 arrives at a destination, to determine that the service has been executed and to perform charging. In this case, the determination as to whether the vehicle has arrived at the destination can be made by obtaining, from the terminal device 200, positional information obtained by the GPS. It is apparent from the description of claims that other embodiments obtained by variously changing or modifying the above-described embodiments are also included in the technical scope of the present invention.

What is claimed is:

1. A navigation system for providing route guidance to a destination for a user comprising:
an information provider configured to provide a program for performing processing of a voice command and a grammar associated with the route guidance, the information provider including,
a transmitter for sending the program, and
an informing means for notifying the user of the program;
a terminal device for providing the route guidance to the user, the terminal device including:
a receiver for receiving the program from the information provider,
a speech recognition unit for enabling the voice command and the grammar,
a navigation executing unit for realizing a navigation function in response to the voice command; and
a server, wherein the server is configured to provide data associated with the program to the information provider.

2. The navigation system of claim 1, wherein the information provider further comprises a data storage unit for storing the grammar and the program.

3. The navigation system of claim 1, wherein the transmitter is configured to provide a data transmission mechanism that may be selected from the following without limitation: a dedicated short range communication mechanism, an active radio frequency identification mechanism, and a frequency modulation multiple wave mechanism.

4. The navigation system of claim 3, wherein the transmitter is configured to transmit to the terminal device only within a given distance.

5. The navigation system of claim 1, wherein the informing means may be selected from the following without limitation: a notice board and an audio based medium.

6. The navigation system of claim 1, wherein the information provider is further configured to transmit authentication data to the server upon a request from the terminal device for a service associated with the program.

7. The navigation system of claim 1, wherein the terminal device further comprises:
input means for manually performing input of a plurality of commands and operation settings; and
display means for displaying information.

8. The navigation system of claim 1, wherein the terminal device further comprises:
a profile database for storing a user profile;
a media database for storing information corresponding with media set by the user as unnecessary media; and
a filter unit for determining when the program is provided to the user based on data corresponding with the profile database and the media database.

9. The navigation system of claim 8, wherein the filter unit is further configured to provide the program to the user based on a current position of the terminal device.

10. The navigation system of claim 8, wherein the filter unit is further configured to provide the program to the user based on an internal clock, wherein the internal clock is responsive to when the terminal device receives the program.

11. The navigation system of claim 6, wherein the server further comprises:
an information providing server for providing data associated with program changes to the information provider;
a data distributing server, wherein
the data distribution server is configured to receive the authentication data from the information provider, wherein
in response receiving the authentication data, the data distribution server is configured to provide a requested data to the information provider, and wherein,
the data distribution server is configured to receive data from the terminal device; and
a charging server for performing charging based on use of the voice command associated with the program.

12. A method for providing route guidance to a navigation device comprising:
causing a server to send a program for performing processing of a voice command and a grammar associated with the route guidance;
causing an information provider to receive the program;
causing the information provider to transmit a notification to a user such that the user is informed of an availability of the program;
if the user utilizes the voice command, causing the navigation device to determine the route guidance associated with the program.

13. The method of claim 12, wherein the notification enabled from the following without limitation: a notice board and an audio based medium.

14. The method of claim 12, wherein the information provider is configured to provide data transmission to enable causing the navigation device to determine the route guidance.

15. The method of claim 14, wherein the information provider comprises a transmitter configured to provide a data transmission mechanism that may be selected from the following without limitation: a dedicated short range communication mechanism, an active radio frequency identification mechanism, and a frequency modulation multiple wave mechanism, wherein the data transmission mechanism is further configured to transmit to the navigation device only within a given distance.

16. The method of claim 12, further comprising before the causing a server to send a program, causing the information provider to transmit authentication data to the server upon a request from the terminal device for a service associated with the program.

17. The method of claim 12, further comprising causing the server to charge when the information provider utilizes the voice command.

18. The method of claim 12, further comprising causing the server to issue a coupon when the information provider utilizes the voice command.

19. A computing device program product for providing route guidance to a navigation device, the computing device program product comprising:
a computer readable medium;
first programmatic instructions for causing a server to send a program for performing processing of a voice command and a grammar associated with the route guidance;
second programmatic instructions for causing an information provider to receive the program;
third programmatic instructions for causing the information provider to transmit a notification to a user such that the user is informed of an availability of the program;
if the user utilizes the voice command, fourth programmatic instructions for causing the navigation device to determine the route guidance associated with the program.

20. The computing device program product of claim 19, further comprising:
fifth programmatic instructions for causing the information provider to transmit authentication data to the server upon a request from the terminal device for a service associated with the program;
sixth programmatic instructions for causing the server to charge when the information provider utilizes the voice command; and
seventh programmatic instructions for causing the server to issue a coupon when the information provider utilizes the voice command.
